(19) United States
(12) Patent Application Publication
(10) Pub. No.: US 2010/0051690 A1
(43) Pub. Date: Mar. 4, 2010

(54) Off Line Micropayment Commerce Transactions Using A Conventional Credit Card

(75) Inventor: Marvin T. Ling, Scottsdale, AZ (US)

Correspondence Address: NOVAK DRUCE + QUIGG LLP, 1300 EYE STREET NW, SUITE 1000 WEST TOWER, WASHINGTON, DC, 20005, US

(73) Assignee: Pay By Click Corporation, Scottsdale, AZ (US)

(21) Appl. No.: 12/546,391

(22) Filed: Aug. 24, 2009

Related U.S. Application Data
(63) Continuation-in-part of application No. 12/026,516, filed on Feb. 5, 2008.
Application No. 12/026,516 is a continuation-in-part of application No. 10/217,859, filed on Aug. 12, 2002, now Pat. No. 7,249,060.
Application No. 10/217,859 is a continuation-in-part of application No. 10/217,871, filed on Aug. 12, 2002, now Pat. No. 6,876,979.
(60) Provisional application No. 61/091,091, filed on Aug. 22, 2008.

(51) Int. Cl. G06K 5/00

(52) U.S. Cl. 235/380

(57) ABSTRACT

A method for completing a transaction including receiving a credit card payment request at a card reader. The payment request can include a payment amount and a micropayment account identification identifying a pre-pay account or a post-pay account. In the event the payment request is for a pre-pay type of account and the payment amount is greater than a balance associated with the account, then a credit card account associated with the micropayment account is charged with a top off amount plus the difference between the payment amount and the remaining balance. In the event, the payment request is for a post-pay type of account and the payment amount is greater than the balance associate with the account, then a credit account associated with the micropayment account is charged with an amount equal to a credit limit plus the difference between the payment amount and the remaining credit.

### FIELD OF THE INVENTION

The present technology relates to conducting off line commerce transactions using a conventional credit card for purchasing goods and services priced at micropayment level.

### BACKGROUND OF THE INVENTION

The commerce transaction using conventional credit cards or various prepaid cards such as IC cards or debit card is growing rapidly. These cards are used for the payment of purchases taken placed primarily in offline. In the case of using conventional credit cards, the minimum amount of payment is usually three or four dollars or preferably more because any purchase less than these amount will be cost prohibitive due to the cost of card transaction processing. The user must use cash or various pre-paid cards such as IC card or debit card for purchasing of items priced in five cents, ten cents, twenty cents or few dollars in micropayment levels.

Various prepaid cards such as IC cards or cards pre loaded with certain amount of money do exist in the market. SUICA card issued by Japan Railway (JR) loaded with pre paid amount of money is used by over 10 million users for train tickets and purchases of goods including low-cost goods at participating merchants in Japan. SUICA requires a special non-contact card reader; therefore the use of SUICA is limited to merchants having a SUICA card reader. Similarly, PASMO is a card issued by subway system companies in Japan. It is also a pre paid card for purchasing subway train tickets and purchasing low cost goods at participating merchants. PASMO also uses a non-contact card reader. SONY offers the Edy card which is also a pre paid card and it can be used to purchase low cost items from participating merchants. Edy card also uses a non-contact card reader.

JCB, the largest credit card company in Japan is issuing a post pay card for micropayment called QUICPay which also uses a non-contact card reader.

SUICA card, PASMO card, Edy card and QUICPay card do provide convenience to the user for fast settlement of train fare or purchases of low cost goods at participating merchants, however these cards present drawbacks. For example, if a user looses his or her SUICA, PASMO or Edy card, the balance of money left in those cards is, for practical purposes, lost. The user may report the loss of the SUICA card, PASMO card or Edy card and requests to invalidate these cards, however it is often too late when reporting of the lose of the card is made.

If a user looses the QUIC Pay card, it is the same as loosing a conventional credit card in that unauthorized use of the card may have been made before the QUICPay card is reported lost and the card is invalidated.

There are many debit cards being used in the United States and other countries. The debit card often requires the entering of Personal Identification Number, PIN. If the debit card is used as a credit card, the customer is required to sign the sales receipt therefore, it is inconvenient and slow down the check out process at the merchant's cashier. Furthermore, if a user looses the debit card, it is like loosing cash.

There are many pre-paid cards issued by department stores or convenience stores in the nation. Pre-paid cards can be used to pay for goods priced at micropayment level—however, the user typically needs to purchase a pre-paid card for each department store or convenience stores since these cards are issued and valid for use only at the specific merchants. Furthermore, the small amount of money left in the pre-paid card, called breakage, is often wasted since the user often neglects to use it. If the user looses a pre-paid card, it is lost like loosing cash from a wallet.

### SUMMARY OF THE INVENTION

It is desirable that a conventional credit card can be used to purchase items costing in the range of five cents, ten cents or few dollars, e.g., micropayment level, as well as goods costing much higher. It is also desirable that the check out process at the merchant site using the credit card uses conventional credit card reader and that it requires no signature so as to maintain a speedy check out process. It is also desirable that the account holder can invalidate the card directly without having to call the credit card company when, e.g., the user discover that the card has been used without authorization, thus minimizing the risk. It is also desirable that micropayment use of a conventional credit card protects the user's privacy.

It is further desirable that the user is automatically registered with the micropayment transaction server computer upon the user's first use of the credit card for purchasing goods costing in micropayment levels. In some embodiments, the micropayment transaction server computer will obtain user's personal information from the credit card issuer's computer data base thus provide the convenience to the user. In some embodiments, the technology will obtain sufficient information to complete the initial transaction, and then obtain additional information subsequently.

It is also desirable, but not required, that the technology provides the operator of the MSP the choice of either to operate the system as a prepaid system or as a post-pay system.

In a prepaid system, the account holder is required to register with the MSP, open an account, and purchase at least a pre-determined initial amount of electronic money for deposit to the account, preferably using the account holder's credit card as provided by the user at the time of the registration. In some embodiments, to simplify the management of accounts, all accounts at the same MSP can have the same initial and Top Off amounts.

In a post pay system, the user is allowed to make purchases within available credit limit called “Negative Top Off” amount again pre-determined by the MSP operator before MSP operator will make actual charge to the user's credit card, e.g., Top Off, as provided by the user at the time of the registration. In some embodiments, to simplify the management of accounts, all users registered at the same MSP will have the same Negative Top Off amount.

In case the account does not have enough money or enough available credit to cover the cost of the purchase, the user is required to add funds to the account (in a pre-pay account) or to make a payment to clear the available credit limit (in a post-pay account). The present technology requires the user add funds to the user's account in an amount that is the shortage of the purchase plus the Top Off amount in the pre paid system, or charge the account holder's credit card the amount that is the shortage for the purchase plus Negative Top Off amount to clear the account and restore the credit limit to Negative Top Off amount in the post paid system. This automatic Top Off instant add fund method in the pre paid system and automatic Negative Top Off instant charge to the account holder's credit card in the post pay system avoids the user to manually enter the payment amount therefore provides convenience and speedy add fund or payment process.

It is also desirable that the use of a credit card allows the user to accumulate incentive points for every purchase even for purchasing of very low cost item such as five cents, ten cents or few dollars that normally are paid in cash without incentive points.

The use of a conventional credit card for purchases of low cost items in the present technology provides the user the convenience without the need to carry small changes, entering PIN or sign at the sale receipt. The merchant will benefit from customer's use of the credit card due to speedy check out thus reduces the operation cost. In addition, the merchant will also benefit from less cash in the cash registers therefore the merchant will have less chance to be the target of the robbery.

Since no credit card information is provided directly to the merchant, the new feature for the credit card as described herein provide privacy and security to the user. In case the credit card is lost or the user finds unauthorized use of the credit card, the technology provides the account holder means to lock the account by changing the pass word or invalidating, de-authorizing, or otherwise preventing use of the credit card ahead of action taken by the credit card company upon the report of the loss of the card.

The account holder can further reduce the risk by setting spending thresholds, e.g., per purchase, per day, per week and/or per month. The account holder may also check the daily transaction records by logging in to the MSP transaction record pages allowing the account holder to discover unauthorized use of the account.

The purchase of low cost items using the conventional credit card will benefit the account holder since it will allow the account holder to accumulate incentive points even for purchases of low cost item such as five cents, ten cents or few dollars micropayment level.

The technology is particularly useful for micropayment commerce transactions in the amount of few cents to few dollars and therefore provides the convenience to the user without the need to carry cash in small changes or entering Personal Identification Number, PIN or sign for the sale receipt that is normally required for using cards such as a conventional credit card or a debit card. Therefore the present technology provides the merchant the benefit for fast checkout with cashier at the cash register.

The use of the conventional credit card for making purchases of goods priced in micropayment level has been infeasible, in part due to the cost of the processing for each transaction. The present technology avoids the regular charge processing of each transaction and routes the transaction to a MSP for processing when the transaction amount is equal or less than a pre set amount of, say $5.00. The processing of the transaction by a MSP does not result in an immediate per transaction cost to the merchant. The transaction using the conventional credit card for micropayment in the present technology differs from the regular use of a conventional credit card or debit card in that it does not require the user's signature for the sales receipt nor entering of user's PIN. The technology automatically registers a user at a MSP upon user's first use of the credit card for purchasing of goods priced in micropayment level at a participating merchant by requesting the user's detail personal information from the credit card issuer's computer data base thus provide convenience to the user. The technology provides a security means for the user to invalidate, temporarily deactivate or de-authorize, or otherwise inhibit use of the credit card in case the user finds unauthorized use of the card and therefore minimizes the loss. The user can further reduce the risk by setting spending thresholds either per purchase, per day, per week or per month. The new feature for the use of the conventional credit card also protects the user privacy in that no personal information is disclosed to the merchant.

A new feature to the conventional credit card is disclosed; the new feature allowing the owner of the credit card to charge purchasing of goods costing in the range of five cents, ten cents or few dollars micropayment level in addition to being able to charge higher cost goods that the conventional credit cards will do now. In preferred embodiments, regular credit card charges are processed by the credit card processing company's server. FIG. 1(a) and FIG. 1(b) describe separation of transactions into regular transaction or micropayment transaction and route the transaction data to regular transaction processing server or micropayment server.

The technology enables faster check out at the merchant cashier without the need to sign the sales receipt or enter PIN thus provide convenience to the user and reduces the merchant operation cost. Various embodiments of the technology variously provide: fast response within one second from micropayment transaction server computer for completion of the micropayment purchasing transaction; accepting surge of purchasing transactions without having to modify or add excessive load to the present card processing software; method and apparatus that provides security and minimizes the loss in case the user looses the credit card or the user account password is stolen; use of a credit card for purchase of low cost item that protects the user privacy; automatic registration with the micropayment transaction server computer without requiring the user to enter the detail of the personal information; lower the cost of each transaction; allow the user to accumulate incentive points even for purchases of low cost item such as five cents, ten cents or few dollars micropayment level; for the issuer of the credit card to operate MSP for handling of micropayment as a pre paid system or as a post pay system.

In a pre-paid system, the payment of the purchase transaction is made from funds available in the user's account. When the funds available in the user's account are not enough to cover the purchase, the method and apparatus provides an easy and fast method for the user to add fund instantly to the user's account to cover the shortage of the cost of the purchase and making the available fund in the user's account to the Top Off amount using the credit card that the user provided at the time of registration.

In the post pay system, the method and apparatus allows a user to make purchase and when the cumulative purchase amount reaches or is to exceed available credit limit, the present technology charge user's credit card provided by the user at the time of registration, the amount so that the user can make the purchase and bring the user's balance to zero and restores the user's available credit limit to the Negative Top off amount.

### BRIEF DESCRIPTION OF THE DRAWINGS

The above and other advantages of the technology will be apparent upon consideration of the following detailed description taken in conjunction with the accompanying drawings, in which like characters refer to like parts throughout and in which:

FIG. 1 (a) is an overview of the networked environment in which the technology is used;

FIG. 1 (b) is another overview of the networked environment in which the technology is used;

FIG. 2 (a) is a diagram of the technology executing on a server of the card processing company;

FIG. 2 (b) is a diagram of the technology executing on a server built in accordance with the principles of the present technology;

FIG. 3 describes a user registration process;

FIG. 4 (a) shows an account balance after each purchasing transaction in a pre-paid system;

FIG. 4 (b) shows an account balance after each purchasing transaction in a post pay system;

FIG. 5 shows a purchasing process;

FIG. 5 (a) shows a purchasing process in a pre-paid system;

FIG. 5 (b) shows a purchasing process in a post pay system;

FIG. 6 describes a purchasing logic when a user registered at a MSP makes purchases at a store of another MSP;

FIG. 7 is an example of the logic when a user makes purchases at a store of a different currency for international commerce transaction.

### DETAILED DESCRIPTION OF THE INVENTION

Conducting off-line micropayment commerce transactions using a conventional credit card is described. The conventional credit card holder registers at a server (Merchant Service Provider, hereafter called MSP) and opens an account. A registered authorized user can purchase goods or services off-line priced at a micropayment level at any participating merchant, preferably using a conventional credit card reader. The use of conventional credit card for such micropayment level has been less feasible due to the prohibitive cost involved in processing the transaction. “Micropayment” as used herein, is a transaction amount that is equal or less than the amount that is set by MSP Operator. Typically, this amount will be the minimum amount where the cost of transaction does not exceed the profit margin. Cost of the transaction is the cost that the credit card processing company charges for processing the transaction. Transaction processing companies include TSYS and First Data.

The conventional credit card processing program is modified so as not to process the transaction using the conventional credit card with the transaction amount equal or less than a preset amount of, say $5.00 or less. Instead, the conventional credit card processing program transfers the transaction to a MSP in which the user registered. The MSP contains the user information, including the cardholder account that contains the amount of money remaining for the pre paid system or available credit limit for the post pay system. For the pre paid system, the cost of the purchase by the user is subtracted from the cardholder's account and for the post pay system, the cost of the purchase is subtracted from the cardholder's available credit limit to complete the transaction.

The user registration at a MSP can be done automatically. The card issuer has the card holder's private information which the card issuer may require the user to provide at the time of the application for the credit card. If a user purchases a product costing at micropayment level at a participating merchant site, the transaction data is routed to the MSP. If the MSP finds that the user is not registered at the MSP, it requests the card issuer to provide the card holder's private information. Embodiments of the technology then request the user to provide Login ID and Password at a later time for login to MSP to access various information regarding user's purchase record, account balance among other information. This completes the registration process. This automatic registration feature provides convenience to the user since the user is not required to enter personal information again which the user already provided at the time of the application for the credit card.

The expansion of the use of the conventional credit card for purchasing low cost goods provides the user the convenience of making purchases of low cost items without the need to carry cash in small changes, entering PIN or sign for the sale receipt that is normally required for cards such as a conventional credit card or a debit card. The merchant will benefit from customer's use of the expanded credit card feature instead of making payment in cash due to speedy check out. In addition, the merchant will also benefit from less cash in the cash registers therefore the merchant will have less chance to be the target of the robbery. The card issuer will benefit from sales increases due to credit card charges made by card owners for purchasing low cost goods in micropayment amount that normally would not have been captured due to user's payments in cash.

The technology provides for conducting business transactions in an off line environment using a conventional credit card for micropayment as well as non-micropayment. The conventional credit cards allow users to charge purchasing of goods usually costing say, five dollars or more. Charges below five dollars are usually cost prohibitive for transaction processing that the merchant and credit card issuer would prefer customers to pay their purchases in cash. The cost of the credit card transaction processing includes a fixed amount of about 35 cents per transaction plus a certain percent of the amount of the transaction. This means any purchases of goods costing in micropayment level such as five cents, ten cents will need to be made in some other methods like debit card or cash. Debit card does allow payment of purchases costing in micropayment levels however payment using debit card often requires entering of PIN or sign the sales receipt. Payment made in cash requires the user and cashier to count the money and changes. Both payment methods will take time and slow down the completion of the transaction. Furthermore, users will be required to carry cash and preferably in small denomination or changes.

Some merchants may prefer cash transactions from cash flow point of views and avoid payments of service charges required from credit card companies but merchants, such as convenience stores that remain open until late in the night may also become the target of potential robbery.

There are many pre paid cards or IC cards available in the market. The pre paid card does allow the user to pay for transaction amount in micropayment levels. However, the user is required to purchase new pre paid card when it runs out of the money or when the remaining amount in the prepaid card is small. This is inconvenient for the user. Pre paid card issuers offer some incentives that sometime attract users. Since pre paid cards can be used only at the merchant sites specified by the pre paid card issuer, a user may end up having several pre paid cards. If a user looses his or her pre paid card, the remaining amount of money in the card is lost.

There are several IC cards that are quite popular in Japan. SUICA card issued by Japan Railway (JR) loaded with pre paid amount of money are used by over 10 millions of users for train tickets and purchases of low cost goods at participating merchants near JR stations in Japan. SUICA card requires a special non-contact card reader therefore the use of SUICA card is limited to merchants having SUICA card reader. Similarly, PASMO card issued by subway systems companies for purchasing subway train tickets and purchasing low cost goods at participating merchants near subway stations in Japan also are being used by millions of users. PASMO card also uses a non-contact card reader. Edy card issued by SONY Corporation requires the payment of initial amount just to own an Edy card and service charges are relatively high. Edy card also requires a non-contact card reader. JCB, the largest credit card company in Japan recently issued QUICPay card for micropayment which is a post pay card like a conventional credit card. QUICPay card also requires non-contact card reader. SUICA card, PASMO card, Edy card and QUIC Pay card do allow payment of purchases priced at micropayment level. SUICA card, PASMO card and Edy card has the disadvantage in that if the card is lost, the remaining money in the card is lost. SUICA card, PASMO card, Edy card and QUICPay card are used only in merchants having the special non-contact card reader and they are used only within Japan since the special non-contact card reader are not available outside of Japan.

The technology proposes to expand the use of a conventional credit card to allow the card holder to make purchases of goods costing in the ranges of five cents, ten cents or higher in micropayment level in addition to purchase of normal price range products with fast check out at the merchant cashier and with limited or no cost to the card issuers for the transaction processing.

The technology includes Top Off for adding money to the account or to extend account credit limit. In some embodiments, the Top Off amount in a pre paid system is the amount of value being used by the technology that is required at the time the prepaid balance falls below a threshold. The amount needed to start the account could also be equal to the Top Off amount. When the balance in the user's account does not cover the cost of the purchases, embodiments of the technology will add money to the account with the amount equal to the shortage of the purchase plus the Top Off amount, using the credit card provided at the time of the registration. The account balance will then be the Top Off amount.

In the post pay system, the cost of the good is subtracted from the account credit limit. When the purchase exceeds the credit limit, the technology will charge the credit card provided at the time of registration the amount equal to the shortage plus Negative Top Off amount which brings the account outstanding credit limit to zero and restores the available credit limit to Negative Top Off amount after the instant payment.

The technology introduces an automatic registration process in which a credit card holder will automatically be registered with the micropayment transaction server computer upon the first use of the credit card for purchasing low cost item at a participating merchant. The micropayment transaction server computer requests the user personal information from the credit card issuer's data base so as to avoid asking the user to re enter user's personal information at the point of purchase thus provide the convenience to the user. The user will be asked to enter User ID and Pass Word at a later time. Because the cost of the purchases are paid for using the electronic money without having the third party involved, the check out process is faster allowing the merchant to reduce the over head cost. The MSP operator will settle with each merchant upon reaching a pre agreed thresholds either by amount or by time.

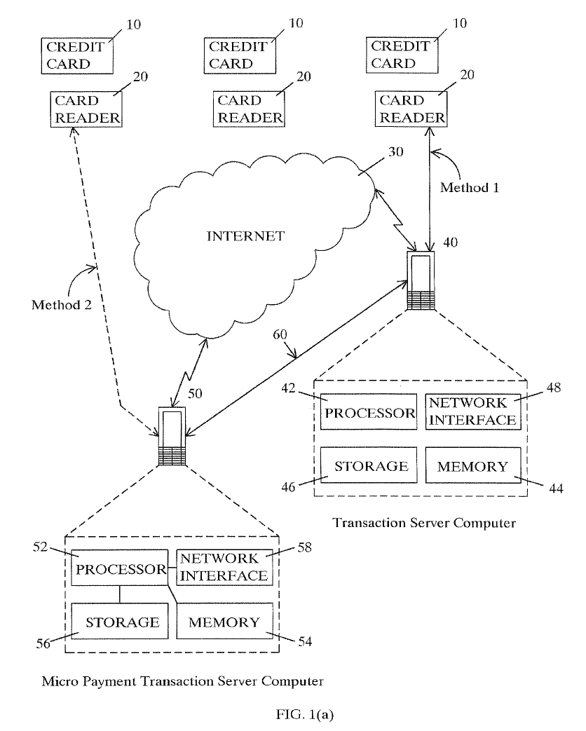

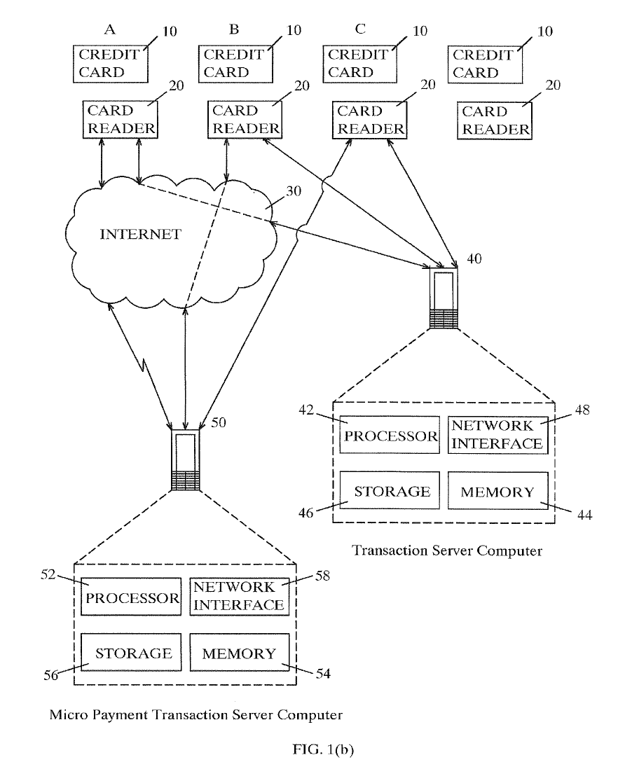

Referring now to FIG. 1(a), a networked environment and apparatus of the technology are described. The transaction server computer 40 is connected to network 30 through network interface 48. Network 30, preferably the Internet, also is a communication network that connects transaction server computer 40 to micropayment transaction server computer 50. Alternatively, transaction server computer 40 may be directly connected to micropayment transaction server computer 50 as shown in bi-directional arrowhead 60. The transaction server computer 40 also is connected to one or more card readers 20 through dedicated communication lines as shown in Method 1.

The transaction server computer 40 distinguishes each purchasing transaction to see if the amount of the transaction is equal to or less than a preset amount. If so, it records the occurrence of the transaction and routes the purchasing transaction data to micropayment transaction server computer 50 for micropayment transaction processing. If the transaction amount is greater than the preset amount, the transaction data is passed to conventional credit card processing program within the transaction server computer 40.

Referring to FIG. 1(a) again. One or more card readers 20 may be connected to micropayment transaction server computer 50, as shown in dotted line labeled Method 2.

The micropayment transaction server computer 50 distinguishes each purchasing transaction to see if the amount of the transaction is greater than a preset amount. If so, it records the occurrence of the transaction and routes the purchasing transaction data to the transaction server computer 40.

In the illustrated embodiment, card readers are connected to transaction server computer, in part, because there has not been a micropayment transaction server in the market for off line purchasing commerce transactions with the transaction amount being in the micropayment amount levels.

The off line purchase with the purchasing amount in the micropayment level needs to be settled as soon as possible, perhaps within one second to be practical. Users will have no patience to charge their purchases in micropayment amount using their credit card if it takes several second to process. The time required to process transaction and obtain authorization for the typical system in Japan is currently approximately 12 seconds or more. Users are used to spending more time for those payment charges that are not in micropayment level because additional time is required for the user to sign the credit card charge sales receipt.

Referring to FIG. 1(b), a network environment of the present technology is described again. Micropayment transaction server computer 50 is connected to network 30 through network interface 58. Network 30 preferably the Internet, is a communication network that connects micropayment transaction server computer 50 to transaction server computer 40. Alternatively, micropayment transaction server computer 50 may be directly connected to transaction server computer 40.

A cardholder registers as a member and opens an account with the Merchant Service Provider (MSP) that resides in micropayment transaction server computer 50. MSP manages the account, handles purchase transactions, adds fund to the account in the pre-paid system, or charges the account holder's credit card in the post pay system. The micropayment transaction server computer 50 includes processor 52, memory 54, storage 56, and network interface 58. In some embodiments, micropayment transaction sever computer 50 executes web server software or a computer interface software through which each purchasing transaction is processed and recorded.

Additionally, micropayment transaction server computer 50 may execute database software, which store information on accounts, purchasing records, products purchased, merchant information, and settlement status MSP has made with each merchant.

It will be understood by one skilled in the art that functions performed by transaction server computer 40 or functions performed by micropayment transaction server computer 50 may alternatively be performed by several computers. In situation where the server is handling a high volume of purchasing transactions, it may be necessary to distribute the tasks performed by transaction server computer 40 and micropayment transaction server computer 50 among several computers for performance reasons.

Alternatively, the conventional credit card reader may be modified to be able to distinguish between the transaction equal or less than a preset amount and the transaction amount greater than the preset amount. Referring to FIG. 1(b), if the amount of the transaction is equal or less than a preset amount, it routes the purchasing transaction data to micropayment transaction server computer 50 for micropayment processing. If the transaction amount is greater than the preset amount, the transaction data is passed to conventional credit card processing program within the transaction server computer 40. Furthermore, the connection between each credit card reader with micropayment transaction server computer 50 or conventional credit card transaction server computer 40 may be made either through dedicated communication line or remotely through Internet or some other means.

Referring again to FIG. 1 (b), credit card reader A is both connected to micropayment transaction server computer 50 and transaction server computer 40 through Internet.

Credit card reader B is connected to micropayment transaction server computer 50 through Internet and it is also connected to transaction server computer 40 through a dedicated communication line. Credit card reader C on the other hand is both connected to micropayment transaction server computer 50 and transaction server computer 40 through dedicated communication lines.

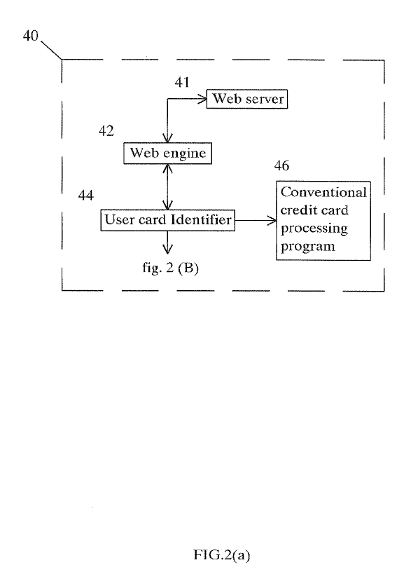

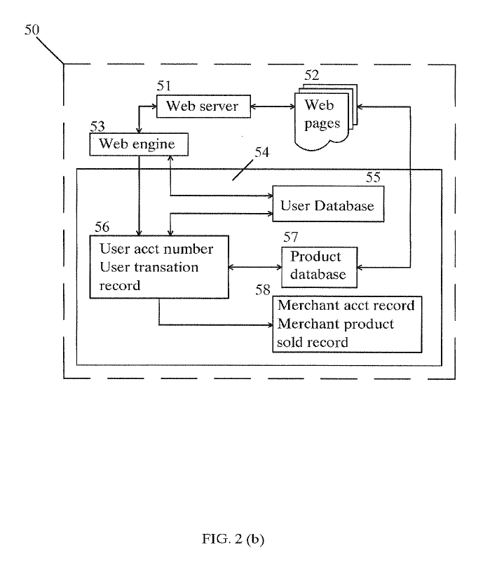

Referring now to FIG. 2 (a), the software executing on transaction server computer 40 in some embodiments of the technology is described in greater detail. A transaction server computer 40 executes Web server 41, which communicates across the Internet with micropayment transaction server computer 50 or communicates directly with micropayment transaction server computer 50 through computer interface (not shown). Web server 41 also connected with card readers through dedicated communication lines or Internet. Web server 41 executes Web engine 42 which tests whether the amount of transaction made using the Credit Card is equal or less than a preset amount. If yes, it routes the transaction data to the micropayment transaction server computer 50 as shown in FIG. 1(a) for further processing. If the transaction amount is greater than a preset amount, the transaction is passed to the Conventional credit card processing program 46. The user card identifier 44 authenticates card, for example to check if the card was reported being lost or the card is a fake card. If the card is not accepted, the transaction is denied.

Referring to FIG. 2(b), software executing on micropayment transaction server computer 50 in some embodiments of the technology is described in greater detail. Micropayment transaction server computer 50 executes Web server 51, which communicates across the Internet with transaction server computer 40 to receive numerous transaction data from purchases made using credit card with the card readers either through Internet or though dedicated communication lines. Alternatively, Web server 51 may receive numerous transaction data directly through computer interface (not shown) between transaction server computer 40 and micropayment transaction server computer 50. Micropayment transaction server computer 50 also executes Web engine 53 which manages user accounts, merchant accounts, and transactions taking place at the merchant through card readers as described in detail herein below.

Web engine 53 communicates between Web server 51 and database server 54 to handle data on users and user's accounts as recorded in User Database 55, User account number and User transactions record 56, Product database 57, Merchant account record and Merchant product sold record 58.

User Database 55 contains information on each user, including the user's name or other identifying information (i.e. credit card number, phone number, address, e-mail address, etc.). User Database 55 also includes the remaining balance on the account. User account number and User transaction record 56 include all purchasing transactions and Add Fund (pre paid system) or credit card charge (post pay system) transaction history corresponding to the user account number. The processing of user's purchasing transaction is performed by micropayment transaction server computer 50.

The transaction server computer 50 provides for at least the user to set spending thresholds, e.g., per purchase, per day, per week and per month so as to minimize the potential loss in case the credit card is lost or the user pass word is stolen. Furthermore, the transaction server computer will send e-mail to the user for each transaction made allowing the user to confirm the purchase. The e-mail message may contain a link for the user to lock his or her account in case he or she finds that there is an unauthorized use of their account.

In some embodiments, product database 57 contains the list of products available for sale by each merchant. Merchant account record and Merchant product sold record 58 includes the settlement record that MSP operator has made with each merchant and the record of all products sold by a merchant which can be used for marketing study as to best selling products and user purchasing trend etc. User account number and User transaction record 56 contains the detail of each purchasing transaction which include merchant name, product purchased, amount, date and time and add fund transactions.

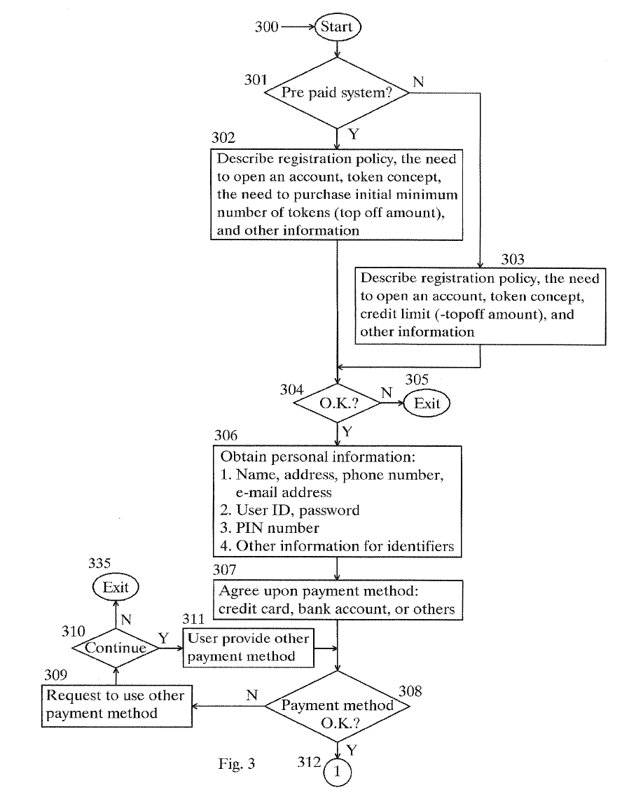

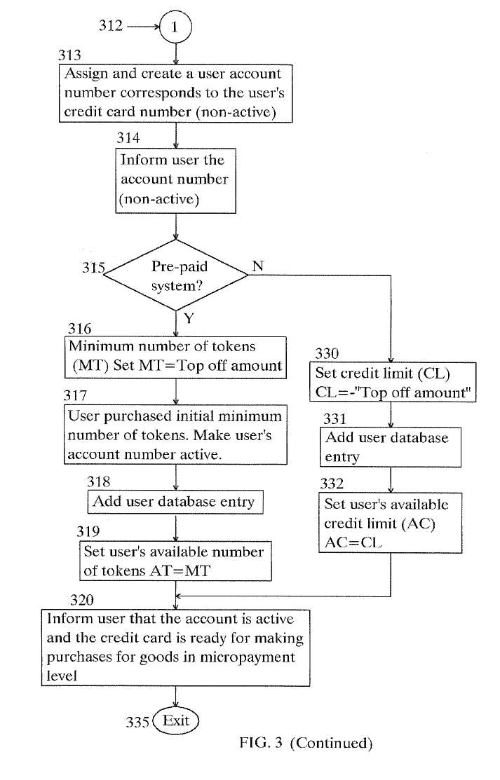

FIG. 3 describes some embodiments of the user registration. In those embodiments, a user can register and establish an account over the network (on-line method) or using telephone, facsimile machine or e-mail address. It should be noted that as used herein, the use of e-mail between the user's personal computer (PC) and the MSP operator of the present technology is considered as an off-line method, since communications using e-mail is not a part of the business transaction between the user's client computer and the server computer of MSP operator.

The registration and establishment of an account with the MSP operator, either using on-line method or off-line method calls for the user to provide the MSP operator the personal information, such as name, User ID, Password, address, telephone number, facsimile machine number, e-mail address, etc. To properly and securely identify a user, the MSP operator may call for additional private information from the user that may include the maiden name of the user's mother, the user's social security number, and a password for use as a Personal Identification Number (PIN). As used herein, this personal private information is collectively called “other identifiers”. These other identifiers are used from time to time to assure proper identification of the user. The user may change his or her Password or PIN at any time.

The registration process starts with inquiry for either pre-paid system or post-pay system in 301, as shown in FIG. 3 For pre-paid system as in 302, the system describes the registration policy, the need to open an account, the need to purchase initial minimum value (in money or tokens) and other information. For post-pay system as in 303, the system describes registration policy, the need to open an account, Credit Limit, and other information. In 304, the system asks if the user wants to proceed. If not, the process exits as in 305.

If the user wants to proceed, the system obtain the user's personal information which includes name, address, phone number, e-mail address, User ID and Pass Word, Personal Identification Number (PIN), and other information required for other identifiers as described in 306. Alternatively the system may obtain most of the user's personal information automatically through credit card issuer's computer system data base and request the user to provide other information that is not in the credit card issuers computer system data base thus provide the user the convenience for registration. In 307, the system agrees upon the user's payment method, either a credit card or the bank account or other methods. In 308, the system decides if the payment method provided by the user is acceptable and if so, it proceeds to 312. If not, the system asks the user for other payment method in 309. In 310, the system checks to see if the user wants to proceed. If so, the process goes to 311 where the user provide other payment method and goes to 308 where the system repeats to check if the payment method provided by the user is acceptable. If the user does not want to proceed, the system proceeds to 335 and exits.

From 312, the process goes to 313 where the system assigns and creates the user an account number that corresponds to the user's credit card number. The account number is inactive at this time. In 314 the process informs the user the account number.

The present technology allows the MSP operator to operate the system either as a pre paid system or as a post pay system. In 315, the process asks if the system is pre paid system. If so, it sets in 316 the minimum value MT (preferably measured, as all quantities hereafter, in dollars, in other embodiments measured in “tokens”) that the user is required to deposit into the user's account. In some embodiments, this minimum value MT is to be called as the Top Off amount. In 317, the user purchased the minimum value for deposit into the user's account. The account is then set to active. In 318, the process adds the user to the database entry and sets the available value AT equal to MT in 319. In 320, the system informs the user that the account is active and it is ready for making purchases of goods in micropayment level. The user completes the registration process as indicated in 335.

If the system is to be operated as a post pay system, the system sets the Credit Limit (CL) to be negative of the Top Off amount as indicated in 330. The system then adds the user to the database entry in 331 and sets the available credit limit AC equal to CL in 332. At 320 the system informs the user that the account is active and ready for making purchases of goods priced in micropayment levels. The user completes the registration process as indicated in 335.

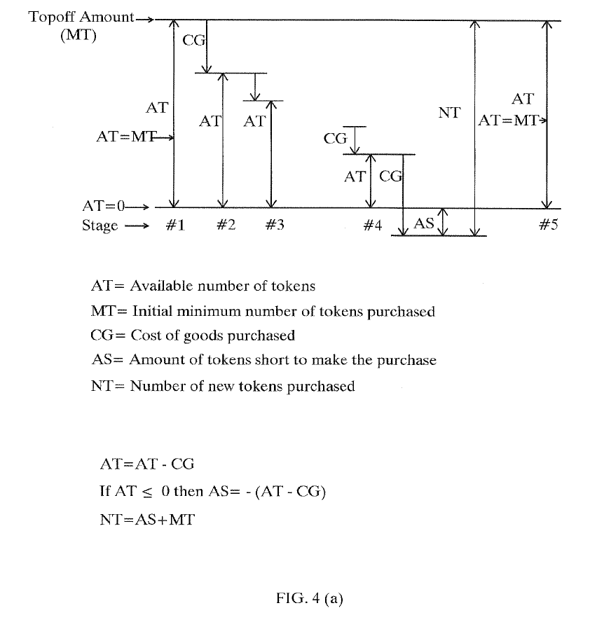

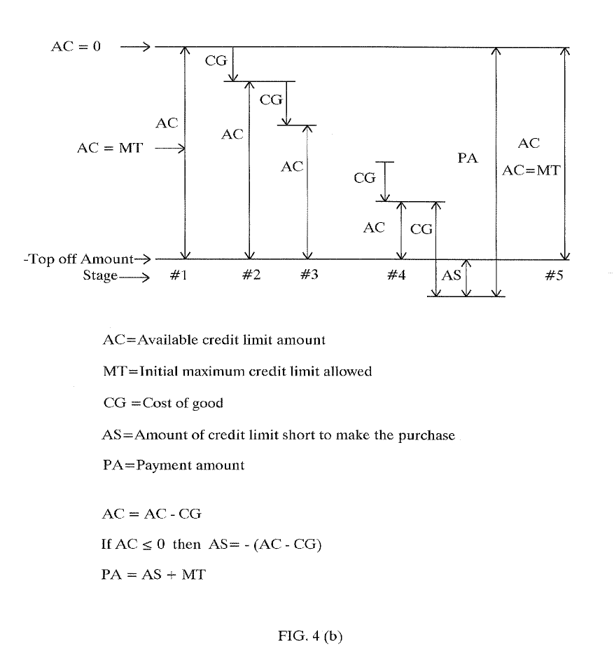

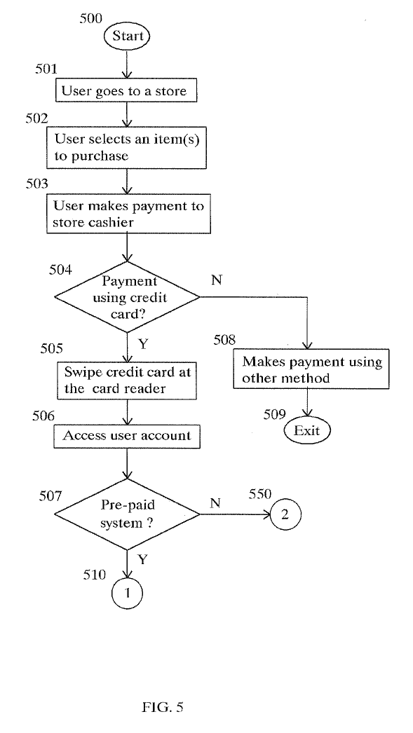

FIG. 4 (a) shows an account balance after each purchasing transaction in a pre-paid system. In stage #1, the account has the value AT that is equal to value purchased MT. In stage #2, a user made a purchase with the cost of goods CG and the cost of good CG is subtracted from the available value AT in the account. Stage #3 and stage #4 show that a user made more purchases and the cost of good for each purchase is subtracted again, from the available value AT in the account. In stage #5, the available value is not enough to cover the cost of goods CG and the amount of value that is short to make the purchase is AS. The system Adds Funds to the account by charging the credit card on record for the account (or the bank account whichever the user's payment method is registered) the amount NT (New value purchased) that is AS, the amount short to make the purchase plus the Top Off amount MT. The resulting balance in the account after this purchasing and Add Fund process is MT, the top off amount. This Add Funds process using Top Off concept without requiring the user to enter the amount to be added to the account as described above provides a means for rapid check out at the merchant cashier.

FIG. 4 (b) shows the user account balance after each purchasing transaction in a post pay system. In initial stage #1, the user has the available credit limit AC equal to the initial maximum credit limit allowed MT when the account is opened. In stage #2, a user made a purchase with the cost of goods CG. The CG is subtracted from the available credit limit AC for the account. Stages #3 and stage #4 show that a user made more purchases and the cost of good CG for each purchase is subtracted again, from the available credit limit AC in the account. In stage #5, the available credit limit AC is not enough to cover the cost of purchase and the amount of the credit limit exceeded is AS. The system automatically charges the credit card associated with the account (or the bank account depending on the payment method registered) the payment amount PA that is AS, the amount exceeded the available credit limit AC plus the initial maximum credit limit allowed MT. The resulting balance in the account after this transaction and the payment amount PA is zero. That gives the account the available credit limit AC back to the initial maximum credit limit allowed MT. Again, this automatically charges the credit card associated with the account (or bank account as provided at registration) to clear the account balance to zero and restore the available credit limit AC to MT without requiring a user to enter the amount to be charged to credit card (or bank account) as described above provides a fast means for check out at the merchant cashier.

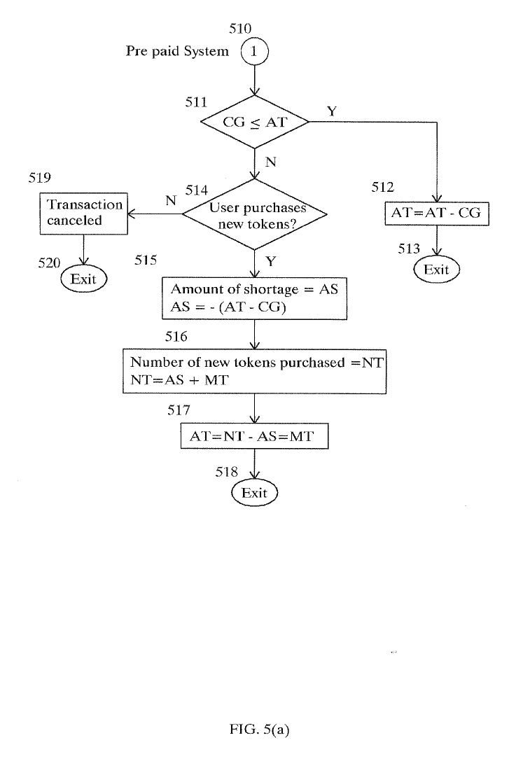

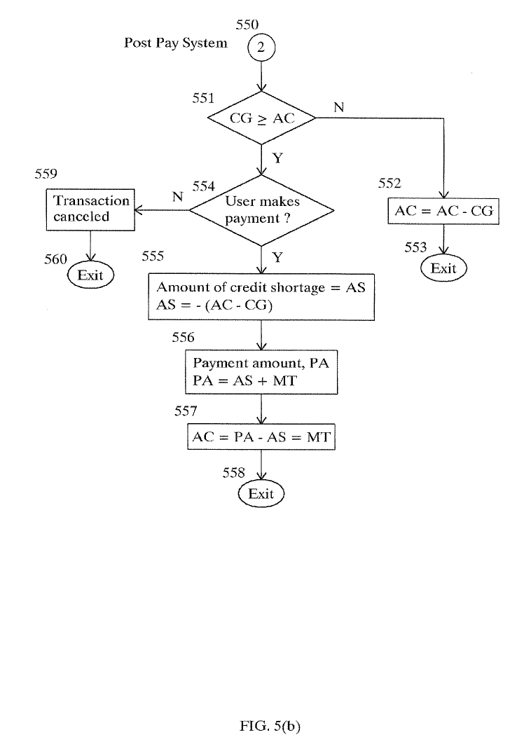

FIG. 5 shows a purchasing process of the present technology. A user goes to a store shown in 501 and selects an item or items to purchase as shown in 502. The user makes payment at a store cashier in 503. In 504, the store cashier asks if the payment is to use credit card. If not, the user makes the payment using other method at 508 that completes the transaction and exit at 509. If the user is to use credit card for the payment, credit card is presented at the card reader in 505. The credit card number allows the process to access the user's account in 506. If the system is a prepaid system, the process goes to 510 in FIG. 5 (a). If the system is a post pay system, the process goes to 550 in FIG. 5 (b).

FIG. 5(a) shows a purchasing process for a pre-paid system. The process asks in 511 if the cost of good CG is less than or equal to the available value AT in the user's account. If yes, the cost of goods is subtracted from the available value AT, or AT=AT−CG, in 512 and exit at 513. If the cost of good CG is greater than the available funds AT, than the process asks if the user wants to purchase new value at 514. If not, it goes to block 519 to cancel the transaction than exit at 520.

If the user want to purchase new value, the amount of shortage AS is computed AS=negative of (AT−CG) as shown in 515 and the number of new value NT to be purchased will be the shortage amount AS plus Minimum value MT or NT=AS+MT as shown in 516. The available value after the purchasing of the goods and new value will be AT=NT−AS=MT as described in 517. This completes the purchasing and Add Fund transactions and the process exits at 518.

FIG. 5(b) shows the purchasing process for post pay system. The process asks in 551 if the cost of goods is less than or equal to the available credit limit AC in the account. If yes, the cost is subtracted from the available credit limit AC or AC=AC−CG in 552 and exit at 553. If the cost of good CG is greater than the available credit limit AC, than the process asks if the user wants to make the payment to clear the credit limit at 554. If not, it goes to block 559 to cancel the transaction than exit at 560.

If the user wants to make the payment to clear the credit limit, the amount of credit shortage (AS) is computed AS=negative of (AC−CG) as shown in 555. The minimum amount of payment PA will be the shortage amount AS plus initial maximum credit limit allowed MT or PA=AS+MT as shown in 556. The available credit limit after the purchasing of the good and the payment will be AC=PA−AS=MT as described in 557. This completes the purchasing and the payment transactions and the process exits at 558.

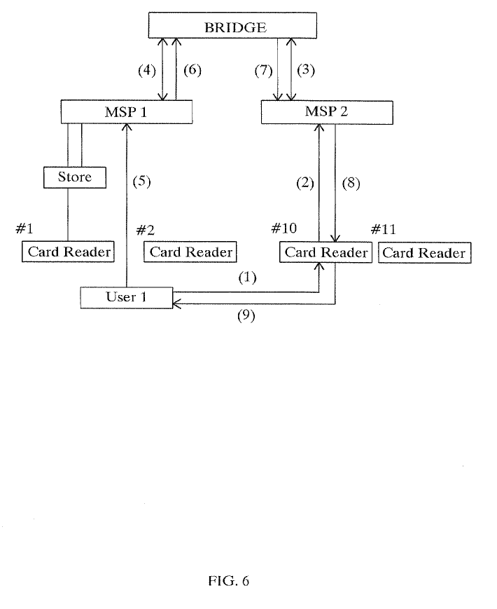

FIG. 6 is a diagram showing the purchasing process when User1 registered at MSP1 makes a purchase at a store belonging to another MSP operator MSP2. In step (1) the user's credit card is read for the purchases the user made. In step (2), the transaction goes to MSP2 for authentication. MSP2 found that the User1 is not a user registered at MSP2 and requests the BRIDGE in step (3) to authenticate the user from other MSP operator, MSP1 in the example shown. BRIDGE inquires MSP1 in step (4) to see if User1 has registered with MSP1 and if so, to see if the User1's account has enough value or available credit to cover the cost of good. If yes, the cost of goods is subtracted from the available value or available credit limit in the User1's account in step (5). In step (6) the process responds to BRIDGE that the purchasing transaction is approved and in step (7) BRDGE informs MSP2 the approval for the transaction. In step (8) MSP2 send the approval signal to card reader and that completes the transaction in step (9).

BRIDGE settles with each MSP operators under its control when the amount or time reaches the thresholds previously agreed upon among all MSP operators. MSP1 may receive a certain commission from MSP2 because User1 registered at MSP1 made a purchase at a merchant of MSP2. In addition, MSP1 and MSP1 may pay BRIDGE for its service. This service fee is called Toll Charges similar to highway toll.

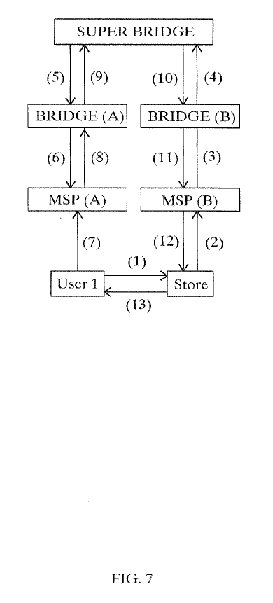

FIG. 7 is an example of the logic when a user makes purchases at a store of a different currency for international transaction. User1 registered at MSP (A) of country A makes a purchase at a store of MSP (B) of country B in step (1). The store tried to obtain the approval for the sale from its MSP (B) in step (2). MSP (B) found that User1 is not a registered user and inquire for approval of purchase from its BRIDGE (B) in step (3). BRIDGE (B) found that User1 is not a member of any of its MSP in their country B and request SUPPER BRIDGE in step (4) to locate User1 for potential international transaction.

In step (5), SUPPER BRIDGE inquires BRIDGE (A) of country A and BRIDGE (A) found that User1 is a registered user of its MSP (A) in step (6). MSP (A) subtracts the cost of good plus service fees for BRIDGE and SUPPER BRIDGE from the available value AT of User1's account (pre paid system) or User1's Available Credit limit AC (post pay system) in step (7). MSP (A) notifies BRIDGE (A) of its approval for the transaction in step (8). BRIDGE (A) in turn notifies SUPPER BRIDGE for the approval of the transaction in step (9). SUPPER BRIDGE notifies BRIDGE (B) for the approval of the transaction in step (10). In step (11), BRIDGE (B) notifies MSP (B) of the approval of the transaction and in step (12), MSP (B) send the approval signal to the store card reader and step 13 completes the international purchasing transaction.

In the above international transaction, it should be noted that there exists exchange rate between two countries. The cost of the good User1 purchased in the country B is adjusted taking into consideration of the exchange rate between the country B and country A where the payment for the cost of the good is to be made from User1's account, in step (8).

SUPPER BRIDGE, BRIDGE (A) and BRIDGE (B) keep the record of each transaction involving exchange rate adjustment. Alternatively, it may be desirable that User1 create an account with MSP (B) if transactions with MSP (B) are to be taken placed frequently. In that case, with the approval from User1, MSP (B) may request transferring of a copy of User1's personal information so that MSP (B) may create a User1 account within MSP (B). The User1 may use the same payment method as registered with MSP (A) or use a different payment method, such as a different credit card for the MSP (B). SUPPER BRIDGE, BRIDGE (A) and BRIDGE (B) may be entitled to service fee to be decided among all parties concerned for completing the user purchase transaction.

While preferred illustrative embodiments of the present technology are described above, it will be evident to one skilled in the art that various changes and modifications may be made without departing from the invention. For example, electronic tokens may be given away in contests or as incentives in addition to awarding incentive tokens proportional to the amount of purchases each credit card company normally awards to the owner of the credit card, or different forms of on-line and off-line payment may be accepted at the option of MSP operators and merchants.

Various aspects of the technology can take the form of a hardware embodiment, a software embodiment or an embodiment containing both hardware and software elements. In some embodiments, the technology is implemented at least in part in software, which includes but is not limited to firmware, resident software, microcode, etc. Furthermore, elements of the technology can take the form of a computer program product accessible from a computer-usable or computer-readable medium providing program code for use by or in connection with a computer or any instruction execution system. For the purposes of this description, a computer-usable or computer readable medium can be any apparatus that can contain, store, the program for use by or in connection with the instruction execution system, apparatus, or device. The medium can be written to or read from by an electronic, magnetic, optical, electromagnetic, infrared, or semiconductor system (or apparatus or device) or a propagation medium (though propagation mediums in and of themselves as signal carriers are not included in the definition of physical computer-readable medium). Examples of a physical computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed:

1. A computer-implemented method for completing a transaction off-line, the method comprising:
in a data processing system comprising a card reader and a micropayment transaction server:
establishing a plurality of micropayment accounts, each account:
having a type comprising one of pre-pay and post-pay, and
associated with a credit card account;
receiving a credit card payment request at the card reader, the payment request comprising:
a payment amount, and
a micropayment account identification;
for each payment request comprising an amount less than or equal to a micropayment amount:
for a request comprising an identified micropayment account of a pre-pay type and a payment amount greater than the remaining balance in the identified account:
charging to the credit card account associated with the identified micropayment account an amount equal to a top off amount plus the difference between the payment amount and the remaining balance;
for a request comprising an identified micropayment account of a post-pay type and a payment amount greater than the remaining credit in the identified account:
charging to the credit card account associated with the identified micropayment account an amount equal to a credit limit plus the difference between the payment amount and the remaining credit.

2. A computer-implemented method for completing a transaction off-line, the method comprising:
in a data processing system comprising a card reader and a micropayment transaction server:
establishing a plurality of micropayment accounts, each account associated with a credit card account;
receiving a credit card payment request at the card reader,
the request comprising a payment amount and a credit card account,
the request not identifying an established micropayment account, and
the request not identifying a credit card account associated with an established micropayment account;
for a received payment request comprising an amount less than or equal to a micropayment amount:
establishing a new micropayment account associated with the credit card account of the received payment request; and
charging to the credit card account associated with the identified micropayment account an amount equal to a top off amount plus the payment amount.
